(19) United States
(12) Patent Application Publication
(10) Pub. No.: US 2005/0091675 A1
(43) Pub. Date: Apr. 28, 2005

(54) Disk conveying device and disk apparatus having the same

(75) Inventor: Masuo Maruyama, Moriguchi-shi (JP)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 10/969,287

(22) Filed: Oct. 20, 2004

(30) Foreign Application Priority Data
Oct. 22, 2003 (JP) 2003-361683

(51) Int. Cl. G11B 17/03; G11B 17/04; G11B 33/02

(52) U.S. Cl. 720/616

(57) ABSTRACT

A disk conveying device provided in a disk apparatus, for conveying a disk between a first position outside of the disk apparatus and a second position inside of the disk apparatus, includes a swivel mechanism for swiveling the disk by 90 degrees substantially within a plane substantially parallel to the recording surface of the disk, at least in part of the conveying route between the first position and second position, thereby the disk conveying device is capable of shortening straight stroke of loading and unloading of disk and reducing the depth size of disk apparatus to realize a compact design.

### BACKGROUND OF THE INVENTION

1. Field of the Invention

The present invention relates to a disk conveying device for conveying a disk as information recording medium between a first position outside of a disk apparatus and a second position inside of a disk apparatus, and a disk apparatus having such disk conveying device.

2. Description of the Related Art

Conventionally, as a disk apparatus for recording and/or reproducing information signal in a disk as information recording medium, it is generally known to convey the disk between a disk loading and unloading position (first position) outside of the disk apparatus, and a recording and reproducing position (second position) inside of the disk apparatus.

It is to be noted that, in the specification, “recording and/or reproducing” refers to “at least one of recording and reproducing” as an abbreviated form of expression. Also, the term “disk” refers to both “disk alone or bare disk” and “disk contained in cartridge”, and is used without any particular distinction unless otherwise specified.

Japanese Patent Laid-open Publication No. H7-161112, for example, discloses a structure in which a conveying device is disposed for conveying a bare disk or disk in container, and when recording and/or reproducing information signal in the disk, the disk is conveyed by the disk conveying device from the disk loading and unloading position (first position) outside of the disk apparatus straightly into the recording and reproducing position (second position above a turntable) inside of the disk apparatus.

Thus, in the conventional disk apparatus, it is general that the disk moves reciprocally on a straight line between the first position and second position, by way of the disk access opening provided at the front side of the disk apparatus.

In a so-called DVD-RAM cartridge, for example, in order to record and/or reproduce information signal in the disk contained inside, preferably, an opening and closing window is provided in the cartridge case, and this window is usually formed to extend in the same direction as the cartridge conveying direction. Therefore, the optical head for recording and/or reproducing in the disk is designed to move reciprocally in the same direction as the disk conveying direction.

In the conventional disk apparatus, however, the conveying device is designed to convey the disk in a straight stroke from the disk loading and unloading position outside of the disk apparatus to the recording and reproducing position inside of the disk apparatus by way of the disk access opening, and the required stroke of conveying the disk is inevitably long. It is hence disadvantageous for realizing a compact design by reducing the depth size of the disk apparatus.

In the case of using a disk in cartridge such as DVD-RAM cartridge, as mentioned above, since the window for recording and reproducing provided in the cartridge is opened to extend in the same direction as the disk conveying direction, the transfer direction of the optical head and the disk conveying direction must be matched. In this case, therefore, in order to assure the transfer range of the optical head, the depth size of the disk apparatus is further increased.

In particular, when the disk apparatus is used by integrally incorporating into a thin type image display device such as liquid crystal display device or plasma display panel (PDP), a further compact design of disk apparatus is demanded. However, in the conventional structure, it is hard to reduce the depth size, and such demand cannot be satisfied.

In the cartridge such as DVD-RAM, generally, the cartridge inserting direction or cartridge holding position is specified, and it is difficult and strange for the user to insert the cartridge in a different direction from the specified ordinary inserting direction, and the operational performance of disk apparatus is spoiled.

In relation to such problems, it may be considered to design the disk apparatus in a so-called vertical installation type of the disk handing position fixed in the vertical direction so as to load and unload the disk in the apparatus by maintaining in the vertical position. However, in this case, the workability is poor when holding the bare disk or cartridge at the conveying device side (specifically on the disk tray), and the stability in conveying motion tends to be lower.

### SUMMARY OF THE INVENTION

The invention is devised in the light of the above technical problems, and it is hence a primary object thereof to realize a compact design of depth size of the disk apparatus, by shortening the straight stroke when loading and unloading the disk, by modifying the conveying direction when conveying the disk between the disk loading and unloading position outside of the disk apparatus and recording and reproducing position inside of the disk.

It is hence a fist aspect of the invention to present a disk conveying device provided in a disk apparatus for recording and/or reproducing information signal in a disk as information recording medium, for conveying the disk between a first position outside of the disk apparatus and a second position inside of the disk apparatus, including a swivel mechanism for swiveling the disk by 90 degrees substantially within a plane substantially parallel to the recording surface of the disk, at least in part of the conveying route between the first position and second position.

In this configuration, the disk is conveyed to swivel by 90 degrees substantially, by the swivel mechanism, within a plane substantially parallel to the recording surface of the disk, at least in part of the conveying route.

It is a second aspect of the invention to present a disk conveying device provided in a disk apparatus for recording and/or reproducing information signal in a disk as information recording medium, for conveying the disk between a first position outside of the disk apparatus and a second position inside of the disk apparatus, including a rectilinear moving mechanism for moving straightly the disk by a specified distance to a disk access opening of the disk apparatus, in part of the conveying route between the first position and second position, and a swivel mechanism for swiveling the disk by 90 degrees substantially within a plane substantially parallel to the recording surface of the disk, in the remaining portion of the conveying route, in which the disk is conveyed from the first position to the second position by attracting the disk from the disk access opening into the disk apparatus straightly by a specified distance by the rectilinear moving mechanism, and then swiveling by 90 degrees substantially within a plane substantially parallel to the recording surface of the disk by the swivel mechanism.

In this configuration, the disk is moved straightly by a specified distance to the disk access opening of the disk apparatus by the rectilinear moving mechanism in part of the conveying route. And, it is conveyed to swivel by 90 degrees substantially within a plane substantially parallel to the recording surface of the disk by the swivel mechanism in the remaining portion of the conveying route. In particular, when conveying the disk from the first position to the second position, the disk is once attracted straightly by a specified distance into the disk apparatus from the disk access opening, and thereafter, it is conveyed to swivel by 90 degrees substantially within a plane substantially parallel to the recording surface of the disk.

In this case, more specifically, the disk conveying device preferably includes further a first gear disposed in a disk holding member for holding the disk, a second gear engaged with the first gear, and a third gear engaged with the second gear and rotated by driving force of a motor, a first coupling member rotatably coupled with a rotary shaft of the first gear and a rotary shaft of the second gear, and a second coupling member rotatably coupled with the rotary shaft of the second gear and a rotary shaft of the third gear, and a guide mechanism for guiding the conveying motion of the disk holding member, disposed on a conveying base for supporting the disk holding member in a surface substantially parallel to the recording surface of the disk, in which the third gear is rotated by a driving force of the motor, thereby the second gear and first gear are rotated sequentially, and the conveying motion of the disk holding member is guided so that, after the disk is attracted by a specified distance, the disk may swivel by 90 degrees substantially within a plane nearly parallel to the recording surface of the disk.

In this configuration, by driving the motor and rotating the third gear, the first gear disposed in the disk holding member is rotated, and hence the disk is attracted, by a specified distance, and the conveying motion of the disk holding member is guided so that, after the disk is attracted by a specified distance, the disk may swivel by 90 degrees substantially within a plane nearly parallel to the recording surface of the disk.

In this case, the disk may be contained in a cartridge.

In the case of the disk contained in a cartridge, the same disk conveying device can be applied. In the disk in cartridge, in particular, since the window for recording and reproduction provided in the cartridge is opened to extend in the same direction as the disk conveying direction, the transfer direction of the optical head and the disk conveying direction must be matched, and the depth size of the disk apparatus is generally increased in order to assure the transfer range of the optical head. However, by applying such disk conveying device, the depth size of the disk apparatus used in the disk in cartridge may be relatively suppressed small.

Further, the disk apparatus of the invention is a disk apparatus for recording and/or reproducing information signal in a disk as information recording medium, having a disk conveying device of any one of the disk conveying devices described above, as a disk conveying device for conveying the disk between a first position outside of the disk apparatus and a second position inside of the disk apparatus.

In this case, when conveying the disk between the first position and second position, the same function as in any one of the disk conveying devices mentioned above can be obtained.

According to the disk conveying device in an aspect of the invention, the disk is conveyed by the swivel mechanism so as to swivel by 90 degrees substantially within a plane substantially parallel to the recording surface of the disk, at least in part of the conveying route between the first position and second position. Therefore, in the conveying range of the disk by swivel motion, the straight stroke of loading and unloading of disk is shortened by a corresponding amount, and the depth size of the disk apparatus can be shortened.

According to the disk conveying device in other aspect of the invention, the disk is moved straightly by the rectilinear moving mechanism by a specified distance to the access opening of disk of the disk apparatus, in part of the conveying route between the first position outside of the disk apparatus and second position inside of the disk apparatus. And, the disk is conveyed by the swivel mechanism by 90 degrees substantially within a plane substantially parallel to the recording surface of the disk, in the remaining portion of the conveying route. Therefore, in the remaining portion of the conveying route of the disk transferred by swivel motion, the straight stroke of loading and unloading of -disk is shortened by a corresponding amount, and the depth size of the disk apparatus can be shortened.

In particular, when the disk is conveyed from the first position to the second position, the disk is straightly attracted from the disk access opening into the disk apparatus by a specified distance, and thereafter the disk is conveyed to swivel by 90 degrees substantially within a plane substantially parallel to the recording surface of the disk. And hence when loading the disk, in a specific conveying range from start of conveying motion, same as in the conventional disk apparatus, the disk is attracted straightly in the ordinary insertion direction, and then the disk is moved by swivel motion. Therefore, the disk does not start to swivel upon start of conveying motion, and there is no strange feel of operation for the user.

In this case, preferably, the device further includes a first gear disposed in a disk holding member for holding the disk, a second gear engaged with the first gear, and a third gear engaged with the second gear and rotated by driving force of a motor, and the third gear is rotated by a driving force of the motor, thereby the second gear and first gear are rotated sequentially. And, the conveying motion of the disk holding member is guided so that, after the disk is attracted by a specified distance, the disk may swivel by 90 degrees substantially within the plane nearly parallel to the recording surface of the disk. As a result, when loading the disk, straight disk attracting motion is executed securely in a specific conveying range upon start of conveying motion, and then the disk swivel securely.

Moreover, the disk conveying device can be applied, not only to a bare disk but also, to a disk in cartridge. And hence the depth size of the disk apparatus used in the disk in cartridge may be suppressed relatively small. In the disk in cartridge, in particular, since the window for recording and reproduction provided in the cartridge is opened to extend in the same direction as the disk conveying direction, the transfer direction of the optical head and the disk conveying direction must be matched, therefore, the depth size of the disk apparatus is generally increased in order to assure the transfer range of the optical head. But, by applying such disk conveying device, the depth size of the disk apparatus used in the disk in cartridge may be relatively suppressed small.

Further, the disk apparatus of the invention includes a disk conveying device of any one of the disk conveying devices described above, as a disk conveying device for conveying the disk as information recording medium between a first position outside of the disk apparatus and a second position inside of the disk apparatus, and hence the same effect as mentioned above can be obtained. That is, basically, the straight stroke of loading and unloading of disk can be shortened, and the depth size of the disk apparatus can be made compact. As a result, when the disk apparatus is used by incorporating integrally in a thin type image display device or the like, the assembling performance can be enhanced.

### BRIEF DESCRIPTION OF THE DRAWINGS

FIG. 1 is a plan explanatory drawing of a disk apparatus showing a state of drawing out a tray in a preferred embodiment of the invention;

FIG. 2 is a front explanatory drawing of the disk apparatus, in an arrow view of Y2-Y2 in FIG. 1;

FIG. 3 is a side explanatory drawing of the disk apparatus, in an arrow view of Y3-Y3 in FIG. 1;

FIG. 4 is a plan explanatory drawing of magnified view of essential parts of disk conveying mechanism of the disk apparatus;

FIG. 5 is a plan explanatory drawing of the disk apparatus showing partly attracted state of tray;

FIG. 6 is a plan explanatory drawing of the disk apparatus showing tray swivel state of tray;

FIG. 7 is a plan explanatory drawing of the disk apparatus showing completely held state of tray;

FIG. 8 is a front explanatory drawing of the disk apparatus corresponding to FIG. 7, in an arrow view of Y8-Y8 in FIG. 7;

FIG. 9 is a side explanatory drawing of the disk apparatus corresponding to FIG. 7, in an arrow view of Y9-Y9 in FIG. 7;

FIG. 10 is a flowchart explaining disk loading operation of the disk apparatus.

### BEST MODE FOR CARRYING OUT THE INVENTION

Preferred embodiments of the invention are specifically described below by referring to the accompanying drawings.

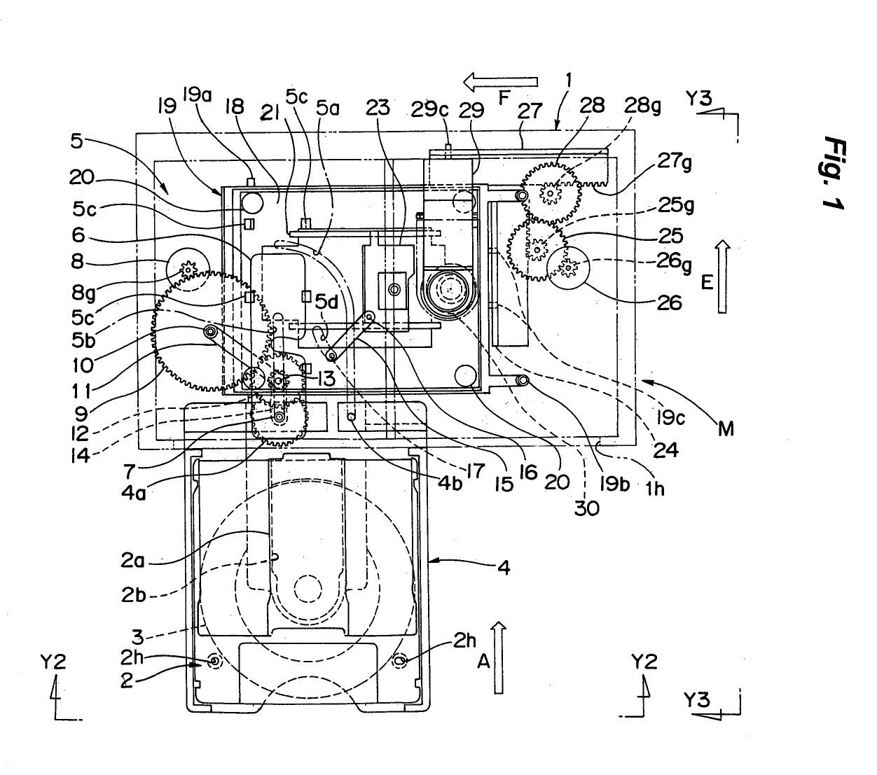

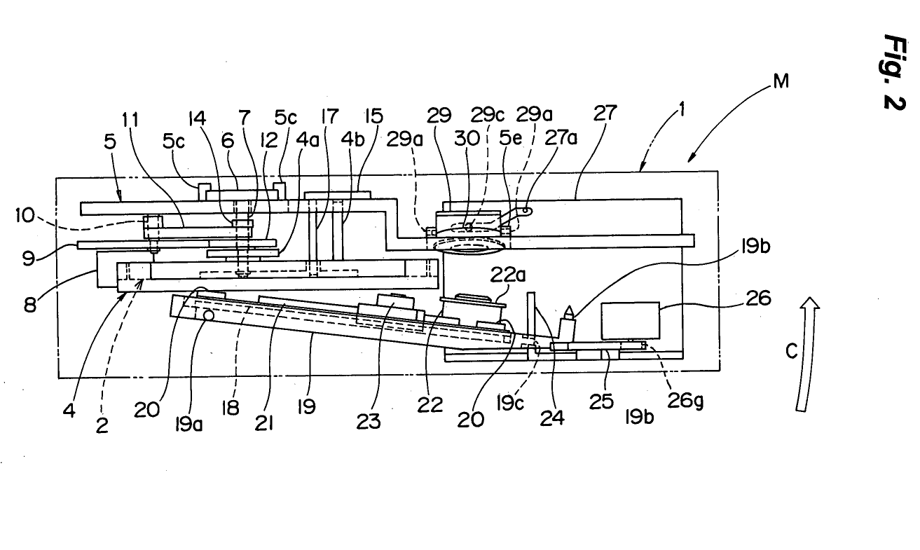

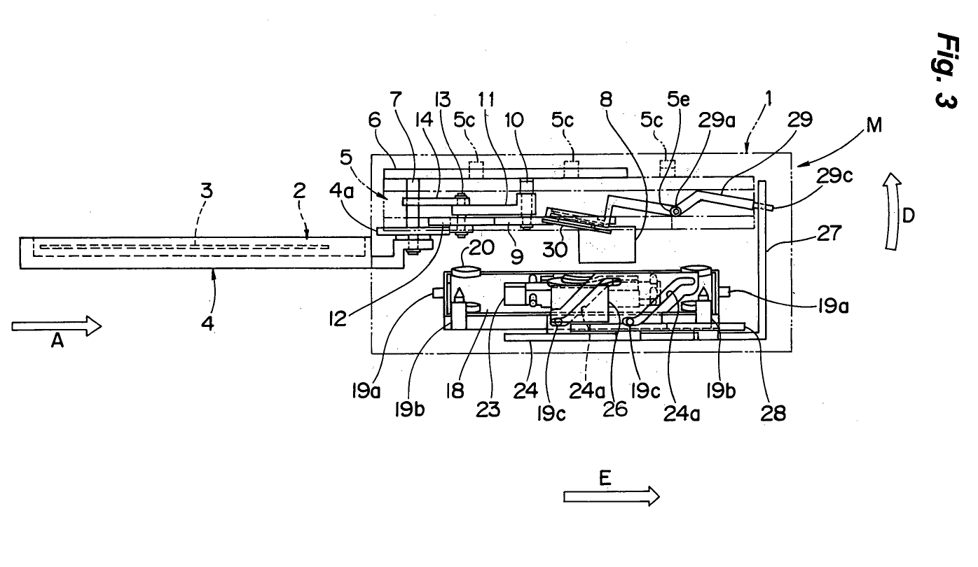

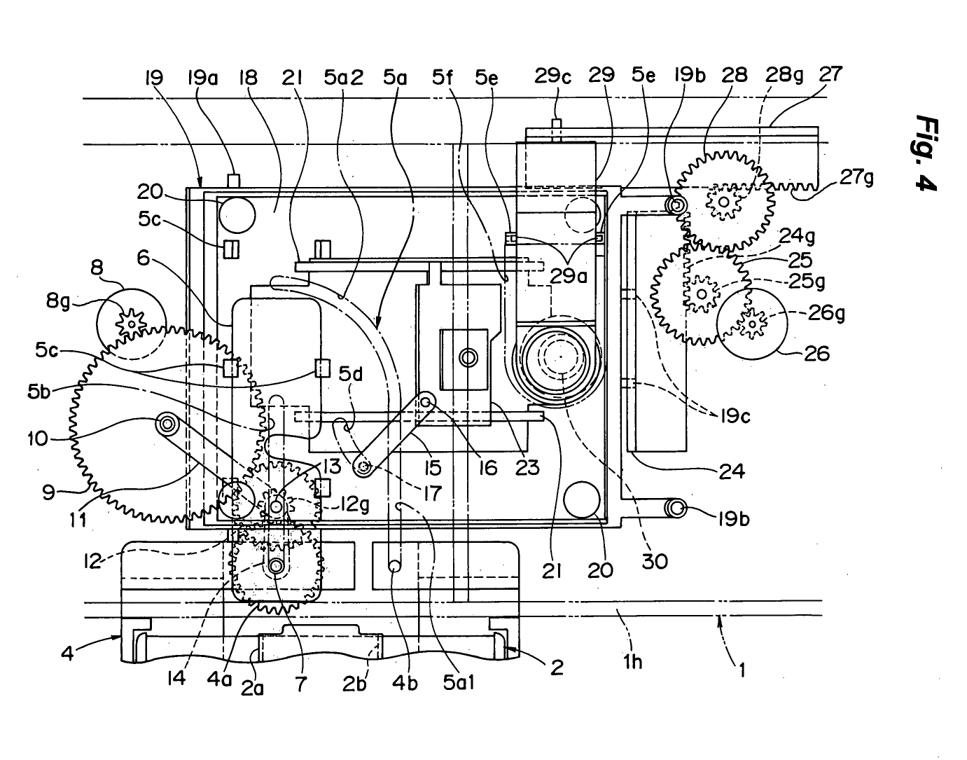

FIG. 1 is a plan explanatory drawing of a disk apparatus showing a state of drawing out a tray in a preferred embodiment of the invention. FIG. 2 is a front explanatory drawing of the disk apparatus, in an arrow view of Y2-Y2 in FIG. 1. FIG. 3 is a side explanatory drawing of the disk apparatus, in an arrow view of Y3-Y3 in FIG. 1. FIG. 4 is a plan explanatory drawing of magnified view of essential parts of disk conveying mechanism of the disk apparatus.

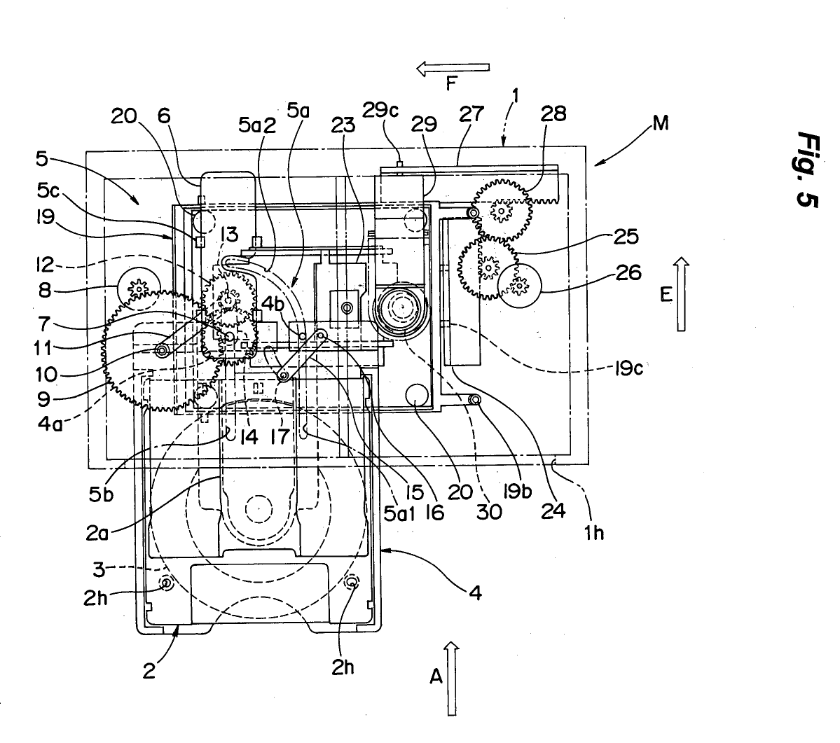

As shown in the drawings, a disk apparatus M in the preferred embodiment includes a box-shaped (rectangular parallelepiped) main body case 1 (chassis), and a disk tray 4 (hereinafter, occasionally referred to “tray” simply) provided in the main body case 1 to be movable in and out. The tray 4 is moved in and out of the main body case 1 by way of a disk access opening 1h provided at the front side of the main body case 1. In FIG. 1 to FIG. 4, as well as in FIG. 5 to FIG. 9 described later, the main body case 1 is indicated by a virtual line (double dot chain line) in order to avoid extremely complicated expression of the drawing.

The tray 4 is a disk holding member for holding a disk 3, and can mount and support a disk alone (so-called bare disk) 3 or a cartridge 2 rotatably containing a disk 3 in its inside. In this preferred embodiment, for example, the disk 3 contained in the cartridge 2 (disk in cartridge) is supported on the tray 4.

The cartridge 2 has a window 2b which is opened when recording or reproducing information signal in the disk 3, and also a shutter 2a for opening or closing the window 2b. The window 2b is formed in a substantially rectangular shape including the portion corresponding to the central part of the disk 3, and when the cartridge 2 is mounted on the tray 4, its longitudinal direction is set to coincide with the inserting direction (arrow A direction in FIG. 1 and FIG. 3) of the cartridge 2. The shutter 2a slides in a direction orthogonal to the longitudinal direction of the window 2b, and is designed to open and close the window 2b.

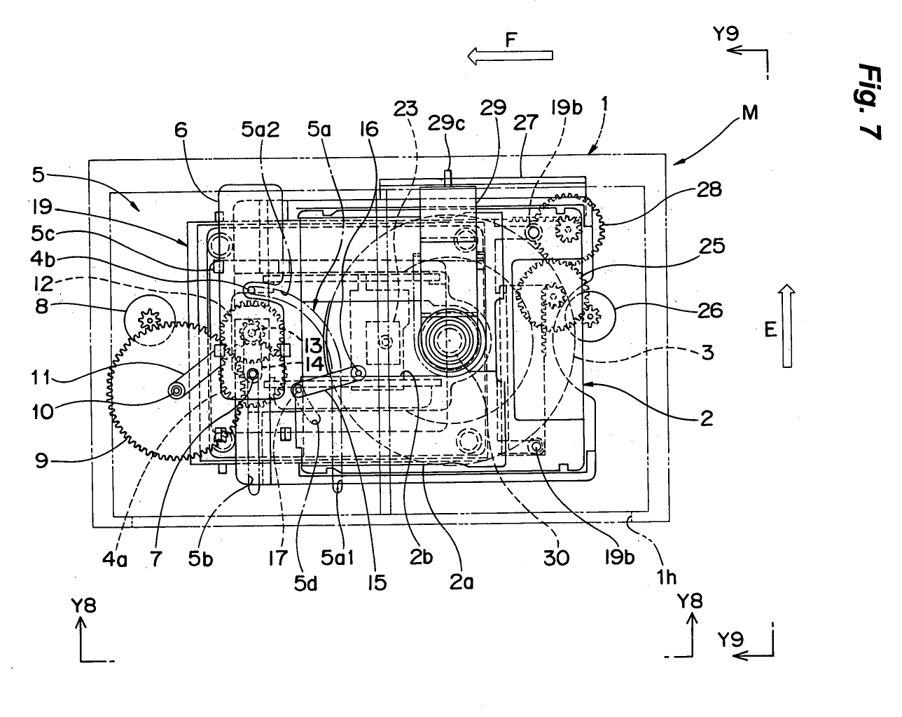

The disk 3 contained in the cartridge 2, being put on the tray 4, is conveyed between a first position outside of the disk apparatus M (disk loading and unloading position: tray withdrawing position shown in FIG. 1 to FIG. 3) and a second position inside of the disk apparatus M (disk mounting position: tray insertion complete position shown in FIG. 7 to FIG. 9 below).

In this preferred embodiment, as described specifically below, the tray 4 is composed to swivel by 90 degrees substantially within a plane substantially parallel to the recording surface of the disk 3 (the plane parallel to the sheet of paper in FIG. 1), in the midst of conveying route between the first position and second position. And, in order to rotate the tray 4, a tray turning gear 4a is provided near the end of insertion side of the tray 4.

Also, in the preferred embodiment, as described specifically below, the tray 4 is moved to swivel by 90 degrees substantially within a plane substantially parallel to the recording surface of the disk 3, after being attracted straightly by a specified distance into the main body case 1 from the disk access opening 1h, when conveying the disk 3 from the first position to the second position. For guiding such moving motion of the tray 4, a tray guide pin 4b is provided in the tray 4.

The main body case 1 also includes a conveying base 5 for supporting principal parts of the conveying mechanism of the disk apparatus M. At the upper side of the conveying base 5, a tray guide plate 6 and a plurality (for example, six in this preferred embodiment) of guide plate regulation pieces 5c for regulating the slide motion of the tray plate 6 are disposed. In FIG. 3, the conveying base 5 is indicated by a virtual line (double dot chain line) in order to avoid extremely complicated expression of the drawing.

The tray guide plate 6 is designed to move the tray 4 straightly in the inserting direction into the main body case 1 (arrow A direction in FIG. 1 and FIG. 3) and in its reverse direction, and by the straight slide motion along the upper surface of the conveying base 5, its sliding direction is guided by the plurality of the guide plate regulation pieces 5c.

On the tray guide plate 6, as clear from FIG. 2 and FIG. 3, one end (upper end, for example, in the preferred embodiment) of a tray turning shaft 7 for rotatably supporting the tray 4 is fixed. The upper end of the tray turning shaft 7 is fixed to the tray guide plate 6 by inserting through a straight groove 5b (straight guide groove described below) provided in the conveying base 5. The tray 4 and tray turning gear 4a are rotatably coupled and supported at the other end of the tray turning shaft 7 and its vicinity (lower side).

The main body case 1 also incorporates a tray drive motor 8 for providing the tray 4 with a driving force. This tray drive motor 8 can be rotated both normally and reversely. An output gear 8g fixed to the output shaft of the tray drive motor 8 is engaged with a tray drive gear 9, and the tray drive gear 9 is engaged with an intermediate gear 12. Further, a small gear 12g (see FIG. 4) of this intermediate gear 12 is engaged with the tray turning gear 4a.

When the tray drive motor 8 is driven to rotate in specified direction, its driving force is sequentially transmitted to its output gear 8g, tray drive gear 9, intermediate gear 12, small gear 12g of the intermediate gear 12, and tray turning gear 4a.

The tray turning gear 4a, intermediate gear 12 (and its small gear 12g), and tray drive gear 9 correspond to the first gear, second gear, and third gear as set forth in the claim, respectively.

In the central part of the tray drive gear 9, a tray drive gear shaft 10 is disposed for rotatably supporting the tray drive gear 9 and drive gear arm 11. As clear from FIG. 2 and FIG. 3, one end (upper end in this preferred embodiment) of the tray drive gear shaft 10 is fixed to the conveying base 5.

As specifically shown in FIG. 4, an intermediate gear shaft 13 is disposed in the center of the intermediate gear 12, and the central part of the intermediate gear shaft 13 is rotatably coupled to the leading end side of the drive gear arm 11. The intermediate gear shaft 13, as clear from FIG. 3, rotatably supports one end side of the intermediate gear arm 14 at the upper side of the drive gear arm 11, and rotatably supports the central part of the intermediate gear 12 at the lower side. The other end side of the intermediate gear arm 14 is rotatably supported on the tray turning shaft 7.

That is, the intermediate gear arm 14 rotatably couples the rotary shaft 7 (tray turning shaft) of the tray turning gear 4a and the rotary shaft 13 (intermediate gear shaft) of the intermediate gear 12, and corresponds to the first coupling member as set forth in the claim. Similarly, the drive gear arm 11 rotatably couples the rotary shaft 13 (intermediate gear shaft) of the intermediate gear 12 and the rotary shaft 10 (tray drive gear shaft) of the tray drive gear 9, and corresponds to the second coupling member as set forth in the claim.

At the upper side of the conveying base 5, a shutter-opener 15 for opening and closing the shutter 2a of the cartridge 2 is disposed. One end of the shutter-opener 15 is rotatably supported on a shutter-opener shaft 16, and the other end has a shutter opening and closing pin 17. The shutter opening and closing pin 17 is engaged with the shutter 2a when the cartridge 2 is inserted into the main body case 1, and moves the shutter 2a at the closing position to the opening position. On the other hand, when the cartridge 2 is delivered outside from the main body case 1, the shutter 2a at the opening position is moved to the closing position.

The conveying base 5 has a straight guide groove 5b which is to be engaged with the tray turning shaft 7 and extending in the inserting direction (arrow A direction in FIG. 1 and FIG. 3) into the main body case 1 of the tray 4. The tray turning shaft 7 can move in the inserting direction (arrow A direction in FIG. 1 and FIG. 3) into the main body case 1 of the tray 4 and in the reverse direction straightly, when the tray guide plate 6 slides and moves straightly on the conveying base 5 while being guided by the plurality of guide plate regulation pieces 5c.

The conveying base 5 also has a swivel guide groove 5a which is to be engaged with the tray guide pin 4a and guiding the swivel motion of the tray guide pin 4a. The swivel guide groove 5a is composed of a straight portion 5a1 parallel to the straight guide groove 5b and substantially equal in length, and an arc portion 5a2 of specified length bent in an arc at a specified curvature from the leading end side of the straight portion. This arc portion 5a2 is set in an arc centered on the end of the inner side in the main body case 1 of the straight guide groove 5b.

The tray guide pin 4a is guided by the swivel guide groove 5a, and when inserting the tray, after moving straightly in the inserting direction (arrow A direction in FIG. 1 and FIG. 3) into the main body case 1 of the tray 4, it can swivel and move within a plane parallel to the disk recording surface. When discharging the tray, it can move in the reverse sequence.

Further, the conveying base 5 has an opening and closing guide groove 5d engaged with the shutter opening and closing pin 17 of the shutter-opener 15, and guiding the moving motion of the opening and closing pin 17. The opening and closing guide groove 5d is formed in an arc shape of specified length centered on the axis of the shutter-opener shaft 16, and the shutter-opener 15 rotates at a specified angle about the axis of the shutter-opener shaft 16 as the shutter opening and closing pin 17 moves as being guided by the opening and closing guide groove 5d.

In FIG. 1 and FIG. 4 to FIG. 7, in order to avoid extremely complicated expression of the drawing, the swivel guide groove 5a, straight guide groove 5b, and opening and closing guide groove 5d are indicated by a virtual line (single dot chain line).

In the tray withdrawing state shown in FIG. 1 to FIG. 3, as the tray drive motor 8 is driven, its driving force is transmitted sequentially to the output gear 8g, tray drive gear 9, and intermediate gear 12 as mentioned above, and further the driving force of the intermediate gear 12 is transmitted to the tray turning gear 4a by way of its small gear 12g.

However, in the state shown in FIG. 1 to FIG. 3, since the tray guide pin 4b of the tray 4 is engaged with the straight portion 5a1 of the swivel guide groove 5a of the conveying base 5, the tray 4 cannot turn about the axis of the tray turning shaft 7.

Further, the tray drive gear shaft 10 and intermediate gear shaft 13 are coupled by way of the drive gear arm 11, and the intermediate gear shaft 13 and tray turning shaft 7 are coupled by way of the intermediate gear arm 14, and the tray turning shaft 7 is engaged with the straight guide groove 5b.

Therefore, when the tray drive gear 9 rotates, the tray turning shaft 7 moves along the straight guide groove 5b, and the tray 4 passes through the disk access opening 1h of the main body case 1, and is conveyed straightly in the inserting direction (arrow A direction in FIG. 1 and FIG. 3) into the main body case 1. At this time, the tray guide pin 4b moves along the straight portion 5a1 of the swivel guide groove 5a.

Thus, in the initial phase of insertion operation into the main body case 1, the tray 4 is straightly conveyed in the inserting direction (arrow A direction in FIG. 1 and FIG. 3) by a distance corresponding to the length of the straight guide groove 5b and the straight portion 5a1 of the swivel guide groove 5a. This straight conveying motion of the tray 4 is guided by the linear motion of the tray turning shaft 7, tray guide pin 4b and tray guide plate 6.

FIG. 5 is a plan explanatory drawing of straightly attracted state of part of the tray in the initial phase of tray insertion operation. As shown in the drawing, when the tray turning shaft 7 reaches the terminal part of the straight guide groove 5b, the straight conveying motion of initial phase of insertion of the tray 4 is terminated. At this time, the tray guide pin 4b reaches the end of the straight portion 5a1 of the swivel guide groove 5a (in other words, the start point of arc portion 5a2 consecutively continuous from the straight portion 5a1). At this moment, the shutter opening and closing pin 17 is stopped still at one end of the opening and closing guide groove 5d, and the shutter-opener 15 does not turn. That is, the shutter 2a of the cartridge 2 remains closed.

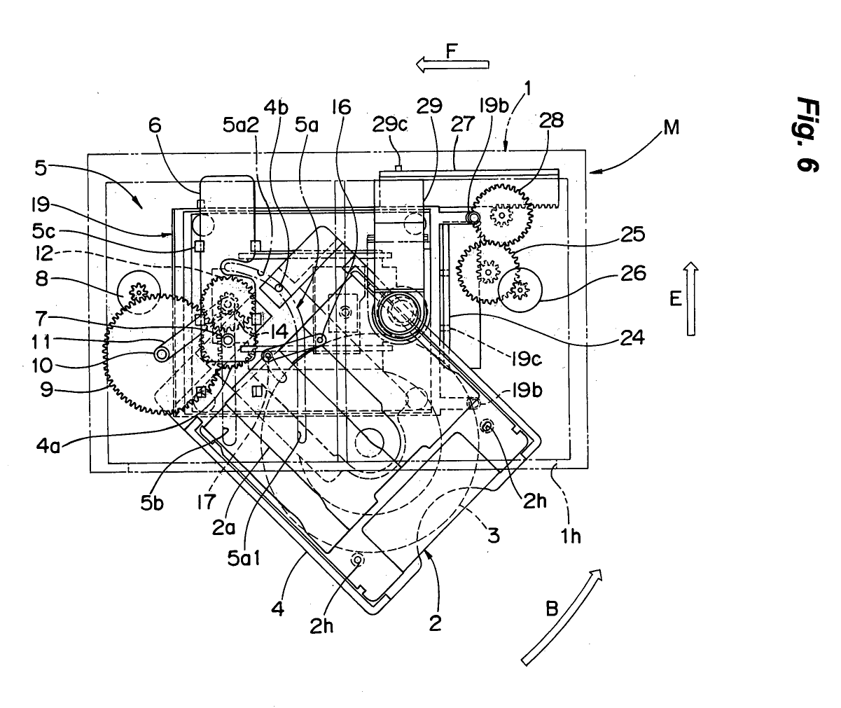

In this state, when the tray drive motor 8 is driven successively, the tray turning gear 4a is also rotated continuously by way of the tray drive gear 9 and intermediate gear 12, but since the tray turning shaft 7 has already reached the terminal part of the straight guide groove 5b, the tray 4 cannot move further straightly, and as shown in FIG. 6, it is attracted into the main body case 1 (see arrow B in FIG. 6) while swiveling and moving in a plane parallel to the disk recording surface (parallel to the sheet of paper of FIG. 6), centered on the axis of the tray turning shaft 7 positioned at the terminal part of the straight guide groove 5b. At this time, the tray guide pin 4b moves along the arc portion 5a2 of the swivel guide groove 5a, and hence the swiveling motion of the tray 4 is guided.

FIG. 6 is a plan explanatory drawing of the disk apparatus M in tray swivel state, showing the tray 4 swiveling about 45 degrees. In this state, the shutter-opener 15 rotates about the axis of the shutter-opener shaft 16 while being guided by the opening and closing guide 5d. And thereby, the shutter opening and closing pin 17 is positioned at the other end of the opening and closing guide groove 5d. The shutter opening and closing pin 17 is engaged with the shutter 2a of the cartridge 2, and thereby the shutter 2a begins to be released.

As the tray drive motor 8 is further driven successively, the tray 4 swivels further about 45 degrees (in a total of about 90 degrees from end of straight motion) in the direction of arrow B from the state shown in FIG. 6, and moves to the complete holding position corresponding to the mounting position of the disk 3. At this time, the tray guide pin 4b reaches near the terminal part of the attracting side of the arc portion 5a2 of the swivel guide groove 5a.

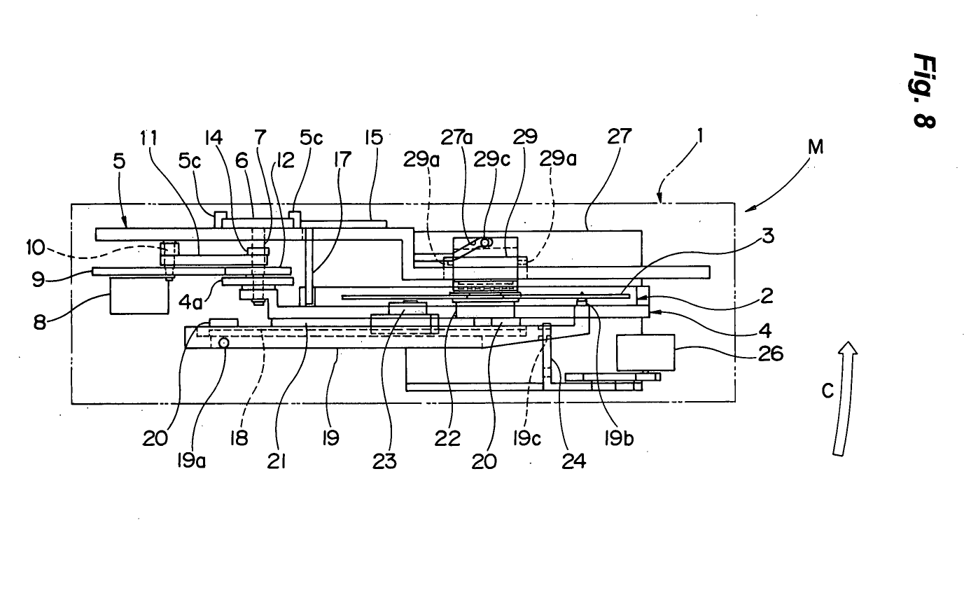

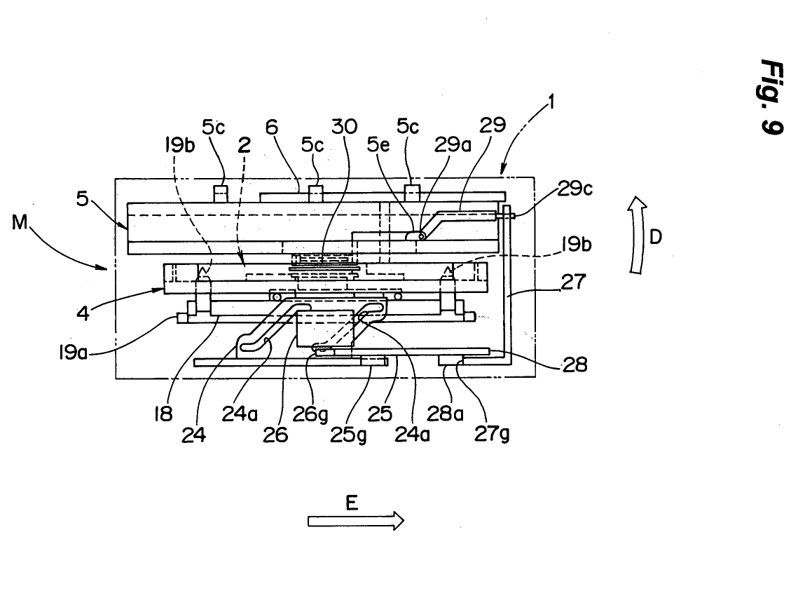

FIG. 7 is a plan explanatory drawing of the disk apparatus M showing completely held state of tray 4, and FIG. 8 is a front explanatory drawing of the disk apparatus M corresponding to FIG. 7, in an arrow view from Y8-Y8 direction in FIG. 7. FIG. 9 is a side explanatory drawing of the disk apparatus M corresponding to FIG. 7, in an arrow view from Y9-Y9 direction in FIG. 7.

As clear from these drawings, in the completely held state of the tray 4, the shutter 2a of the cartridge 2 is completely released by the shutter opening and closing pin 17, and an optical head 23 and a turntable 22a of a disk motor 22 described below can be inserted into the inside of the cartridge 2 from the window 2b.

As described herein, according to the disk conveying device of the preferred embodiment, in part of the conveying route between the first position (disk loading and unloading position) outside of the disk apparatus M and the second position (complete storing position) inside of the disk apparatus M, the tray 4 mounting the disk 3 moves straightly by a specified distance only to the disk access opening 1h of the main body case 1, along the straight guide groove 5b and the straight portion 5a1 of the swivel guide groove 5a. In the remaining portion of the conveying route, it is conveyed to swivel by 90 degrees substantially within a plane substantially parallel to the recording surface of the disk 3 along the arc portion 5a2 of the swivel guide groove 5a. Therefore, in the remaining portion of the conveying route of the tray 4 conveyed while swiveling, the straight stroke of loading and unloading of the disk 3 is shortened by the corresponding extent, and the depth size of the disk apparatus M can be shortened.

In particular, when conveying the disk 3 from the first position to the second position (that is, when loading), the tray 4 is straightly attracted by a specified distance into the main body case 1 from the disk access opening 1h, and thereafter the tray 4 is conveyed to swivel by 90 degrees substantially within a plane substantially parallel to the recording surface of the disk 3. Accordingly, when loading the disk 3, in a specific conveying range from start of conveying operation, same as in the conventional disk apparatus, the disk is attracted straightly in ordinary inserting direction (direction of arrow A in FIG. 1 and FIG. 3), and then the disk 3 is moved to swivel. Therefore, the disk 3 does not start to swivel at the beginning of conveying operation, and strange sense of operation for the user can be avoided.

In this case, the structure includes the tray turning gear 4a disposed in the tray 4 for holding the disk 3, intermediate gear 12 engaged with the tray turning gear 4a, and tray drive gear 9 engaged with the intermediate gear 12 to rotate by the driving force of the tray drive motor 8, and as the tray drive gear 9 is rotated by the driving force of the tray drive motor 8, the intermediate gear 12 and tray turning gear 4a are put into rotation sequentially. And, the conveying motion of the tray 4 is guided so that, after attracting the tray 4 by a specified distance, the tray 4 swivels 90 degrees substantially within a plane parallel to the recording surface of the disk 3. As a result, when loading the disk 3, in a specific conveying range after start of conveying operation, the disk is securely attracted straightly, and in the later process the tray 3 is securely moved to swivel.

The disk conveying device of the preferred embodiment can be applied to the so-called bare disk, and further when applied to the disk 3 in cartridge as in the preferred embodiment, the depth size of the disk apparatus M used in the disk 3 in cartridge can be suppressed relatively small.

That is, the extending direction (longitudinal direction) of the window 2b for recording and reproducing provided in the cartridge 2 and the disk conveying direction are different in direction except for the straight moving portion, and as mentioned below the straight motion portion and the moving direction of the optical head 23 are different by about 90 degrees, so that the depth size of the disk apparatus M used in the disk in cartridge can be suppressed small.

Nearly in the center of plan view of the main body case 1, a rectangular optical transfer base 18 accommodated in a transfer base holder 19 of square frame is disposed. The optical transfer base 18 is elastically supported on the transfer base holder 19 of square frame by way of a plurality of (four in the preferred embodiment) vibration-proof rubber 20.

The transfer base holder 19 has a pair of holder turning shafts 19a extending in a direction parallel to the inserting direction of the tray 4 into the main body case 1 (direction of arrow A in FIG. 1 and FIG. 3). And, the transfer base holder 19 is designed to rotate in the vertical direction (direction of arrow C in FIG. 2 and its reverse direction) about the axis of the pair of holder turning shafts 19a, and thereby the optical transfer base 18 is rotated in the vertical direction. The holder turning shafts 19a, 19a are rotatably supported on the main body case 1 by way of bearing mechanism not shown.

The transfer base holder 19 further includes a pair of positioning pins 19b to be fitted into positioning hole 2h of the cartridge 2 and positioning hole of tray 4 (see broken line around the positioning hole 2h in FIG. 1, FIG. 5, and FIG. 6) when the disk in cartridge is positioned at a predetermined mounting position inside of the disk apparatus.

On the optical transfer base 18, a disk motor 22 for rotating and driving the disk 3 is mounted, together with an optical head 23 for recording and/or reproducing information signal in the disk 3 mounted on the disk motor 22, and a pair of guide shafts 21 for guiding the optical head 23 in the radial direction of the disk 3. The turntable 22a is integrally fixed to the output shaft of the disk motor 22, and the disk 3 is to be mounted on this turntable 22a.

Although not shown specifically in the drawings, a drive motor and its power transmission mechanism for moving the optical head 23 along the guide shafts 21 are also mounted on the optical transfer base 18.

The disk motor 22 is disposed at a side close to one end of the optical transfer base 18, and the holder turning shafts 19a, 19a project at the side of the transfer base holder 19 near the end remote from the disk motor 22.

On the other hand, near the end of the transfer base holder 19 at the side close to the disk motor 22, an elevating mechanism for elevating and lowering the end portion of the transfer base holder 19 is disposed. The elevating mechanism includes a cam plate 24 (first cam plate) disposed opposite to the end of the transfer base holder 19, a cam drive motor 26 for driving the first cam plate 24, and a cam drive gear 25 (first cam drive gear) for transmitting the driving force of the cam drive motor 26 to the first cam plate 24. The first cam drive gear 25 is engaged with a second cam drive gear 28 for driving a second cam plate 27 described below. The cam drive motor 26 can rotate both normally and reversely.

The first cam plate 24 has rack teeth 24g in a direction parallel to arrow E in FIG. 1 and FIG. 3, and a small gear 25g of the first cam drive gear 25 is engaged with rack teeth 24g of the first cam plate 24.

As the cam drive motor 26 is driven, its driving force is transmitted to the first cam plate 25 sequentially by way of the output gear 26g, first cam drive gear 25, small gear 25g of the first cam drive gear 25, and rack teeth 24g. As a result, the first cam plate 24 is driven in a direction along the rack teeth 24g (direction parallel to arrow E in FIG. 1 and FIG. 3).

As known well from FIG. 3, the first cam plate 24 has a pair of cam grooves 24a extending in oblique directions, and the transfer base holder 19 has engaging pins 19c, 19c to be engaged with the cam grooves 24a, 24a projecting from the end face facing the first cam plate 24.

When the first cam plate 24 slides in a direction along the rack teeth 24g, the engaging pins 19c are guided by the cam grooves 24a to move in the vertical direction, and the end portion of the transfer base holder 19 facing the first cam plate 24 is elevated or lowered.

That is, the driving force of the cam drive motor 26 is transmitted to the transfer base holder 19 by way of the first cam plate 24, and the transfer base holder 19 rotates in the vertical direction (direction of arrow C in FIG. 2 and its reverse direction) about the axis of the holder turning shaft 19a. And thereby, the optical transfer base 18 also rotates in the vertical direction.

The conveying base 5 has an opening 5f (opening for clamper: see FIG. 4) formed in a specified region including the portion corresponding to the turntable 22a of the disk motor 22, and a damper 30 is disposed in this opening 5f.

The damper 30 is supported at one end of a damper arm 29, and near the other end of the damper arm 29, a cam plate 27 (second cam plate) is disposed for elevating and lowering the other end of the damper arm 29. In an intermediate part of the damper arm 29, a pair of arm turning shafts 29a are provided integrally with the damper arm 29. Each arm turning shaft 29a is rotatably supported by a bearing 5e provided on the conveying base 5. And, the damper arm 29 rotates in the vertical direction (direction of arrow D in FIG. 3 and its reverse direction) about the axis of the arm turning shaft 29a, thereby moving the damper 30 in the vertical direction.

The lower part of the second cam plate 27 has rack teeth 27g in a direction parallel to arrow F in FIG. 1. Near the lower part of the second cam plate 27, a second cam drive gear 28 engaged with the first cam drive gear 25 is disposed. And, a small gear 28g of the second cam drive gear 28 is engaged with the rack teeth 27g of the second cam plate 27.

As the cam drive motor 26 is driven, its driving force is transmitted to the second cam plate 27 sequentially by way of the output gear 26g, first cam drive gear 25, second cam drive gear 28, its small gear 28g, and rack teeth 27g. As a result, the second cam plate 27 is driven in a direction along the rack teeth 27g (direction parallel to arrow F in FIG. 1).

As shown in FIG. 2, the second cam plate 27 has a cam groove 27a extending in an oblique direction, and an engaging pin 29c to be engaged with the cam groove 27a is projecting from the end face facing the second cam plate 27 of the damper arm 29.

When the second cam plate 27 slides in a direction along the rack teeth 27g, the engaging pin 29c is guided by the cam groove 27a to move in the vertical direction, and the end portion of the damper arm 29 facing the second plate 27 is elevated or lowered.

That is, the driving force of the cam drive motor 26 is transmitted to the damper arm 29 by way of the second cam plate 27, and the damper arm 29 rotates in the vertical direction (direction of arrow D in FIG. 3 and its reverse direction) about the axis of the arm turning shaft 29a, and thereby the damper 30 also moves in the vertical direction.

Although not shown specifically in the drawings, a control circuit board having a control unit for controlling the operation of the disk apparatus M is disposed in the bottom of the main body case 1. Driving force sources such as disk motor 22, cam drive motor 26 and optical head driving motor (not shown), various sensors, switches, indicators and other control elements of the disk apparatus M are connected to this control unit (not shown) so as to exchange signals.

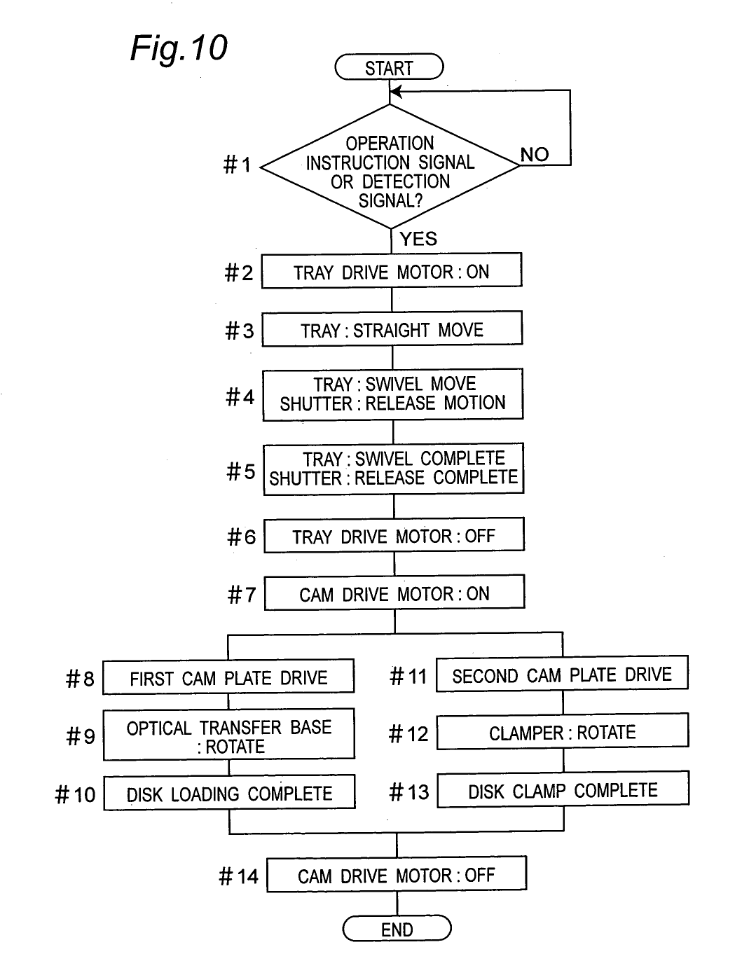

The disk loading operation of the disk apparatus M having such configuration is explained below while referring to the flowchart in FIG. 10.

First, in the tray withdrawing state shown in FIG. 1 to FIG. 3, the disk 3 is mounted alone or in a state contained in the cartridge 2, on the tray 4 drawn out from the main body case 1 of the disk apparatus M. That is, the disk 3 is at the disk loading and unloading position outside of the disk apparatus M. In this preferred embodiment, the disk 3 is contained in the cartridge 2, but the operation of the disk apparatus M is basically same if the disk is used alone (bare disk).

In the state shown in FIG. 1 to FIG. 3, in order to convey the tray 4 into the main body case 1 of the disk apparatus M, the transfer base holder 19 is in a state of rotating in a direction reverse to arrow C in FIG. 2 (state shown in FIG. 2), about the axis of the holder turning shaft 19a. That is, the disk motor 22 and optical head 23 on the optical transfer base 18 are evacuated downward. The clamp arm 29 is in a state of rotating in a direction reverse to arrow D in FIG. 3 (state shown in FIG. 3), about the axis of the arm turning shaft 29a. That is, the damper 30 is evacuated upward. The tray turning shaft 7 is positioned at the drawing-out side end of the straight guide groove 5b, and the tray guide pin 4b is positioned at the drawing-out side end of the straight portion 5a1 of the swivel guide groove 5a. The shutter opening and closing pin 17 is positioned at the drawing-out side end of the opening and closing guide groove 5d, and the shutter 2a of the cartridge 2 is closed.

In this explanation of operation, concerning the operating elements such as the tray 4, cartridge 2, optical head 23 and damper 30, the state as shown in FIG. 1 to FIG. 3 is called the initial state.

In this initial state, for example, by input of operation instruction signal from operation means such as an operation switch (not shown), or detection signal from a sensor (not shown) for detecting insertion operation of the tray 4 in the direction of arrow A in FIG. 1 and FIG. 3, into a control unit (not shown) of the control circuit board, loading operation of the disk 3 is started. The sensor (not shown) for detecting insertion operation of the tray 4 maybe realized by a known device.

By the input of operation instruction signal or insertion operation detection signal (Yes at step #1), the tray drive motor 8 is driven (step #2), and the tray drive gear 9, intermediate gear 12, and tray turning gear 4a are sequentially driven as described above, and the tray turning shaft 7 moves straightly in the direction of arrow A in FIG. 1 to FIG. 3 along the straight guide groove 5b, and thereby the tray 4 is moved straightly in the initial phase of insertion (step #3). This straight motion of the tray 4 continues until the tray turning shaft 7 reaches the terminal part of the attracting side of the straight guide groove 5b as shown in FIG. 5. As a result, part of the tray 4 is straightly attracted in the direction of arrow A in FIG. 1 to FIG. 3.

As the tray drive motor 8 is driven successively, as shown in FIG. 6, in the state of the tray turning shaft 7 being secured at the terminal part of the attracting side of the straight guide groove 5b, the tray 4 is attracted into the main body case 1 while swiveling and moving in the direction of arrow B in FIG. 6 about the axis of the tray turning shaft 7 in a plane-parallel to the disk recording surface. At this time, the tray guide pin 4b moves along the arc portion 5a2 of the swivel guide groove 5a, and thereby the swivel motion of the tray 4 is guided. Thus, the motion of the tray 4 is transferred from straight motion to swivel motion. The shutter 2a of the cartridge 2 is engaged with the shutter opening and closing pin 17, and is released (step #4).

When the tray drive motor 8 is further driven successively, as shown in FIG. 7 to FIG. 9, the tray 4 swivels by about 90 degrees from after end of straight motion, and moves to the complete storing position corresponding to the loading position of the disk 3. At this time, the tray guide pin 4b reaches nearly to the terminal part of the attracting side of the arc portion 5a2 of the swivel guide groove 5a. At this moment, the shutter 2a of the cartridge 2 is completely released. Thus, the swivel motion of the tray 4 and the releasing motion of the shutter 2a are completed (step #5).

Accordingly, the detection signal from the detection sensor or detection switch (not shown) for detecting completion of swivel motion of the tray 4 is put in the control unit, and driving of the tray drive motor 8 is stopped (step #6). After stopping of the tray drive motor 8, the cam drive motor 26 is driven to rotate in specified direction (step #7).

As the cam drive motor 26 is driven, as mentioned above, the first cam plate 24 is driven in a direction parallel to arrow E in FIG. 1 and FIG. 3, sequentially by way of the first cam drive gear 25, its small gear 25g, and rack teeth 24g (step #8). And, through this first cam plate 24, the transfer base holder 19 rotates upward (direction of arrow C in FIG. 2) about the axis of the holder turning shaft 19a. Consequently, the optical transfer base 18 also rotates upward until parallel to the disk 3 (step #9). In this state, the disk 3 is mounted on the turntable 22a of the disk motor 22, and information signal can be recorded or reproduced by the optical head 23. That is, loading motion of the disk 3 is over (step #10).

Further, as the cam drive motor 26 is driven, as mentioned above, the second cam plate 27 is driven in a direction of arrow F in FIG. 1, sequentially by way of the first cam drive gear 25, second cam drive gear 28, its small gear 28g, and rack teeth 27g (step #11). And, through this second cam plate 27, the damper arm 29 rotates downward (direction of arrow D in FIG. 3) about the axis of the arm turning shaft 29a. Consequently, the damper 30 also moves downward (step #12). As a result, the disk 3 is held between the turntable 22a of the disk motor 22 and the damper 30, and the clamp motion is over (step #13). Afterwards, driving of the cam drive motor 26 is stopped (step #14), and control of loading operation of disk 3 is completed.

By this series of inserting operation, when the disk 3 stored in the main body case 1 of the disk apparatus M is taken out to the non-loading position outside of the apparatus M, a series of unloading operation is done in the reverse procedure of the above-described inserting operation.

That is, by turning on the disk unloading switch (not shown), an unloading operation instruction signal of disk 3 is put into the control unit (not shown), and the cam drive motor 26 is driven to rotate in reverse direction of the loading operation. As a result, the second cam plate 27 is driven, and the damper arm 29 rotates upward (reverse direction of arrow D in FIG. 3) about the axis of the arm turning shaft 29a, and the clamper 30 is moved upward, and the clamp state is canceled.

So as to operate substantially parallel to the clamp state canceling operation, the first cam plate 24 is driven, and thereby the transfer base holder 19 rotates downward (reverse direction of arrow C in FIG. 2) about the axis of the holder turning shaft 19a. Thereby, the optical transfer base 18 also rotates downward, so that the disk 3 is unloaded from the turntable 22a of the disk motor 22.

In this way, the disk motor 22 and optical head 23 on the optical transfer base 18 are evacuated downward, while the damper 30 is withdrawn upward. It is thus ready to discharge the tray 4.

When driving of the cam drive motor 26 is stopped, the tray drive motor 8 is driven to rotate in reverse direction of loading operation. As a result, the tray drive gear 9, intermediate gear 12, and tray turning gear 4a are sequentially put in rotation. And, the tray 4 swivels in reverse direction of arrow B in FIG. 4. Along with swivel motion of the tray 4, the shutter 2a of the cartridge 2 is closed.

After swivel motion of about 90 degrees, when the tray guide pin 4b reaches the straight portion 5a1 from the arc portion 5a2 of the swivel guide groove 5a, the turning motion of the tray 4 is stopped, and the tray drive gear 9 rotates successively, and thereby the tray 4 moves in opposite direction of arrow A in FIG. 1 and FIG. 3, and is conveyed to the first position (disk loading and unloading position) outside of the disk apparatus M. Thus, the cartridge 2 can be taken out of the tray 4.

As explained herein, according to the disk apparatus M of the preferred embodiment, when conveying the disk 3 between the disk loading and unloading position outside of the disk apparatus M and the recording and reproducing position inside of the disk apparatus M, by modifying the conveying direction appropriately, the straight stroke for loading and unloading of disk 3 can be shortened, and the depth size of the disk apparatus M can be made compact. As a result, when this disk apparatus M is used by integrally assembling in a thin type image display device or the like, its assembling performance can be enhanced.

In the disk conveying device and disk apparatus of the invention, when conveying the disk between the disk loading and unloading position outside of the disk apparatus and the recording and reproducing position inside of the disk apparatus, the straight stroke can be shortened, and the depth size of the disk apparatus can be made compact, and the invention can be effectively applied in the disk apparatus for recording and/or reproducing information signal in the disk as information medium.

In the foregoing explanation, the conveying operation of the disk 3 (that is, tray 4) is a combination of straight motion and swivel motion, but all disk conveying operation may be realized by swivel motion. In this case, the user may feel something strange in operation, but the depth size of the disk apparatus can be further shortened.

Thus, the invention is not limited to the preferred embodiment alone, but may be freely changed and modified within the scope not departing from the true spirit thereof.

1. A disk conveying device provided in a disk apparatus for recording and/or reproducing information signal in a disk as information recording medium, for conveying the disk between a first position outside of the disk apparatus and a second position inside of the disk apparatus, comprising:
a swivel mechanism for swiveling the disk by 90 degrees substantially between within a plane substantially parallel to the recording surface of the disk, at least in part of the conveying route between the first position and second position.

2. A disk conveying device provided in a disk apparatus for recording and/or reproducing information signal in a disk as information recording medium, for conveying the disk between a first position outside of the disk apparatus and a second position inside of the disk apparatus, comprising:
a rectilinear moving mechanism for moving straightly the disk by a specified distance to a disk access opening of the disk apparatus, in part of the conveying route between the first position and second position, and
a swivel mechanism for swiveling the disk by 90 degrees substantially within a plane substantially parallel to the recording surface of the disk, in the remaining portion of the conveying route,
wherein the disk is conveyed from the first position to the second position by attracting the disk from the disk access opening into the disk apparatus straightly by a specified distance by the rectilinear moving mechanism, and then swiveling by 90 degrees substantially within a plane substantially parallel to the recording surface of the disk by the swivel mechanism.

3. The disk conveying device of claim 2, further comprising:
a first gear disposed in a disk holding member for holding the disk, a second gear engaged with the first gear, and a third gear engaged with the second gear and rotated by driving force of a motor,
a first coupling member rotatably coupled with a rotary shaft of the first gear and a rotary shaft of the second gear, and a second coupling member rotatably coupled with the rotary shaft of the second gear and a rotary shaft of the third gear, and
a guide mechanism for guiding the conveying motion of the disk holding member, disposed on a conveying base for supporting the disk holding member in a surface substantially parallel to the recording surface of the disk,
wherein the third gear is rotated by a driving force of the motor, and the second gear and first gear are rotated sequentially, and after the disk is attracted by a specified distance, the conveying motion of the disk holding member is guided so that the disk may swivel by 90 degrees substantially within a plane nearly parallel to the recording surface of the disk.

4. The disk conveying device of claim 1, wherein the disk is contained in a disk cartridge.

5. A disk apparatus for recording and/or reproducing information signal in a disk as information recording medium, comprising:
a disk conveying device for recording and/or reproducing information signal in a disk as information recording medium for conveying the disk between a first position outside of the disk apparatus and a second position inside of the disk apparatus, the disk conveying device including a swivel mechanism for swiveling the disk by 90 degrees substantially between within a plane substantially parallel to the recording surface of the disk, at least in part of the conveying route between the first position and second position.

6. The disk conveying device of claim 2, wherein the disk is contained in a disk cartridge.

7. The disk conveying device of claim 3, wherein the disk is contained in a disk cartridge.

8. A disk apparatus for recording and/or reproducing information signal in a disk as information recording medium, comprising:
a disk conveying device for conveying the disk between a first position outside of the disk apparatus and a second position inside of the disk apparatus, the disk conveying device including:
a rectilinear moving mechanism for moving straightly the disk by a specified distance to a disk access opening of the disk apparatus, in part of the conveying route between the first position and second position, and
a swivel mechanism for swiveling the disk by 90 degrees substantially within a plane substantially parallel to the recording surface of the disk, in the remaining portion of the conveying route,
wherein the disk is conveyed from the first position to the second position by attracting the disk from the disk access opening into the disk apparatus straightly by a specified distance by the rectilinear moving mechanism, and then swiveling by 90 degrees substantially within a plane substantially parallel to the recording surface of the disk by the swivel mechanism.

9. The disk apparatus of claim 8, further comprising:
a first gear disposed in a disk holding member for holding the disk, a second gear engaged with the first gear, and a third gear engaged with the second gear and rotated by driving force of a motor,
a first coupling member rotatably coupled with a rotary shaft of the first gear and a rotary shaft of the second gear, and a second coupling member rotatably coupled with the rotary shaft of the second gear and a rotary shaft of the third gear, and
a guide mechanism for guiding the conveying motion of the disk holding member, disposed on a conveying base for supporting the disk holding member in a surface substantially parallel to the recording surface of the disk,
wherein the third gear is rotated by a driving force of the motor, and the second gear and first gear are rotated sequentially, and after the disk is attracted by a specified distance, the conveying motion of the disk holding member is guided so that the disk may swivel by 90 degrees substantially within a plane nearly parallel to the recording surface of the disk.

10. The disk apparatus of claim 5, wherein the disk is contained in a disk cartridge.

11. The disk apparatus of claim 8, wherein the disk is contained in a disk cartridge.

12. The disk apparatus of claim 9, wherein the disk is contained in a disk cartridge.
